(19) United States
(12) Patent Application Publication
(10) Pub. No.: US 2026/0018827 A1
(43) Pub. Date: Jan. 15, 2026

(54) CONNECTOR UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroya TANAKA, Mie (JP); Yuta KANEMATSU, Mie (JP); Jaeyeon KIM, Mie (JP); Sunghyun BYUN, Mie (JP)

(21) Appl. No.: 18/995,141

(22) PCT Filed: Jul. 20, 2023
(86) PCT No.: PCT/JP2023/026582

§ 371 Date: Jan. 16, 2025

(30) Foreign Application Priority Data
Jul. 27, 2022 (JP) 2022-119371

(51) Int. Cl. H01R 13/533; H01R 13/6581

(52) U.S. Cl. CPC H01R 13/533; H01R 13/6581

(57) ABSTRACT

A connector unit includes a first connector and a second connector. The first connector includes a first terminal fitting. The first terminal fitting includes a first connecting portion. The second connector includes a second terminal fitting, a housing and a shield shell. The housing includes an insertion hole, into which the first connecting portion is inserted, and a second connecting portion is arranged to be contactable with the first connecting portion in the insertion hole. The first terminal fitting integrally includes a resilient deforming portion for resiliently deforming the first connecting portion in a direction separating from the second connecting portion as contacting the second connecting portion. The first connecting portion is pressed against the second connecting portion and the second connecting portion is pressed against the shield shell via an insulating member by a resilient restoring force of the resilient deforming portion.

### TECHNICAL FIELD

The present disclosure relates to a connector unit.

### BACKGROUND

Conventionally, a connector unit in which a first connector and a second connector are conductively connected to each other is known, and heat generation between connecting portions of first and second terminal fittings energized by contacting each other when the first and second connectors are connected is problematic. Accordingly, Patent Document 1 discloses an example in which a second connector is provided with a structure for dissipating heat generated between connecting portions. That is, the second connector is provided with a second terminal fitting including a second connecting portion to be connected to a first connecting portion provided in a first terminal fitting, a wire connected to a wire connecting portion of the second terminal fitting and a shield shell made of metal for covering the wire connecting portion of the second terminal fitting and the wire, and structured such that the wire connecting portion and the shield shell are integrated by an insert-molded insulating resin portion. In this connector unit, the wire connecting portion of the second terminal fitting is integrated with the shield shell by being covered with no gap left by the insulating resin portion filled to fill up an air layer in the shield shell by insert molding. Therefore, heat generated in a contact part of the first and second connecting portions is quickly transferred and dissipated to the shield shell made of metal from the insulating resin portion without via the air layer, whereby the heat dissipation of the connector unit is improved.

### PRIOR ART DOCUMENT

### Patent Document

Patent Document 1: JP 2018-113119 A

### SUMMARY OF THE INVENTION

### Problems to be Solved

However, in the connector unit described in Patent Document 1, if short shots or voids (gaps) occur due to resin fluidity when the insulating resin portion is molded, desired heat dissipation performance cannot be exhibited and the heat dissipation performance is thought to possibly vary. Further, since a part of the terminal fitting to be held in contact with the insulating resin portion is the wire connecting portion, a problem that a distance from the second connecting portion (contact part with the first connecting portion) having a largest heat dissipation amount on an electrically conductive path to the shield shell, which is a heat dissipating part, is long and thermal resistance is large has been inherent.

Accordingly, a connector unit is disclosed which can suppress a variation in heat dissipation performance and improve the heat dissipation performance by a shorter heat dissipation path.

### Means to Solve the Problem

The present disclosure is directed to a connector unit with a first connector and a second connector, the first connector including an insulating terminal block and a first terminal fitting, the first terminal fitting including a base end portion held in the terminal block and a first connecting portion provided on a tip side projecting from the terminal block, the second connector including a second terminal fitting having a second connecting portion to be connected to the first connecting portion, an insulating housing for accommodating the second terminal fitting and a shield shell for covering an outer surface of the housing, the housing including an insertion hole, the first connecting portion being inserted and arranged in the insertion hole, the second connecting portion being arranged to be contactable with the first connecting portion in the insertion hole, the first terminal fitting integrally including a resilient deforming portion for resiliently deforming the first connecting portion in a direction separating from the second connecting portion as contacting the second connecting portion, and the first connecting portion being pressed against the second connecting portion and the second connecting portion being pressed against the shield shell via an insulating member by a resilient restoring force of the resilient deforming portion.

### Effect of the Invention

According to the connector unit of the present disclosure, it is possible to suppress a variation in heat dissipation performance and improve the heat dissipation performance by a shorter heat dissipation path.

### BRIEF DESCRIPTION OF THE DRAWINGS

FIG. 1 is a perspective view showing a connector unit according to a first embodiment in a connected state of a first connector and a second connector.

FIG. 2 is a right side view of the connector unit shown in FIG. 1.

FIG. 3 is a longitudinal section enlargedly showing an essential part of a cross-section along III-III in FIG. 2.

FIG. 4 is a transverse section enlargedly showing a cross-section along IV-IV in

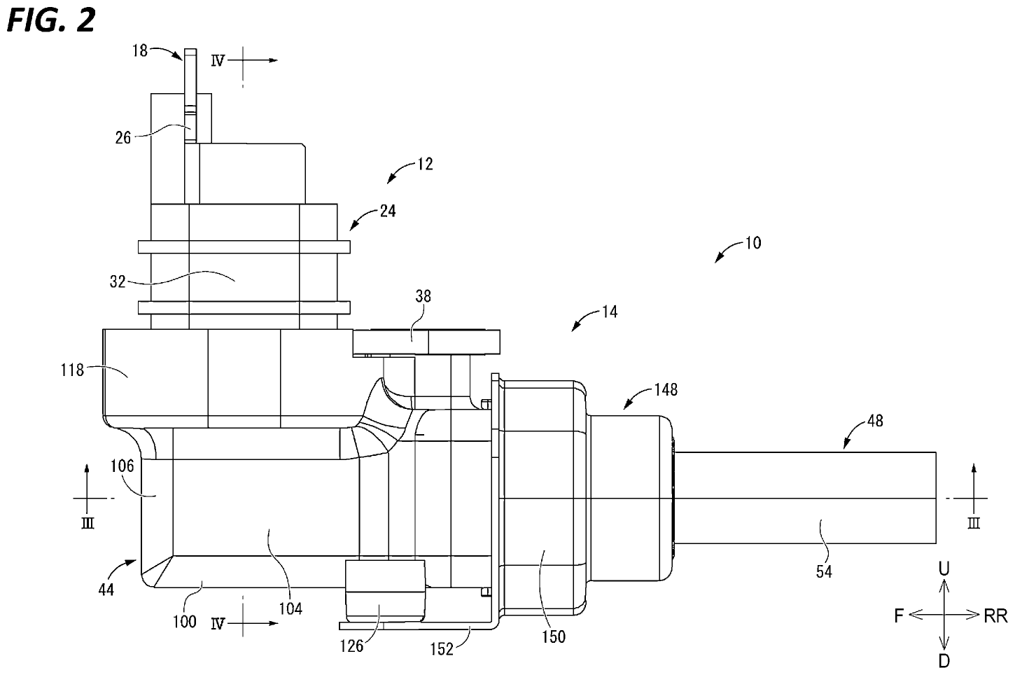

FIG. 2.

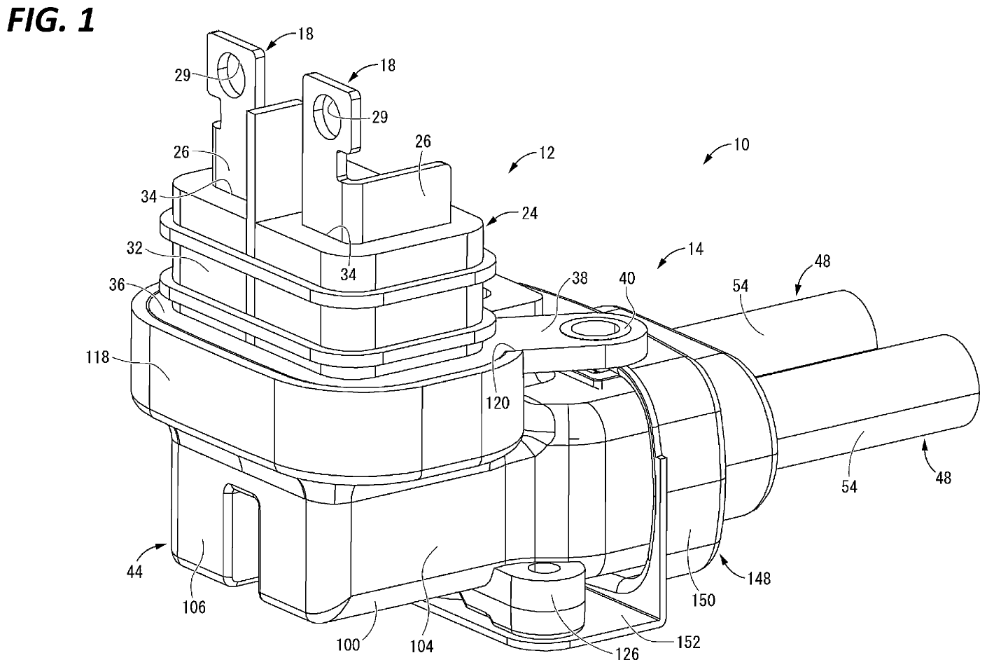

FIG. 5 is a perspective view showing the connector unit shown in FIG. 1 in a separated state of the first and second connectors.

FIG. 6 is a front view showing the first connector constituting the connector unit shown in FIG. 1.

FIG. 7 is a plan view showing the second connector constituting the connector unit shown in FIG. 1.

FIG. 8 is an exploded perspective view of the second connector shown in FIG. 7.

FIG. 9 is a perspective view showing a state where a second terminal fitting and an insulating member are assembled with a housing in the second connector shown in FIG. 7 when viewed from a left side surface side.

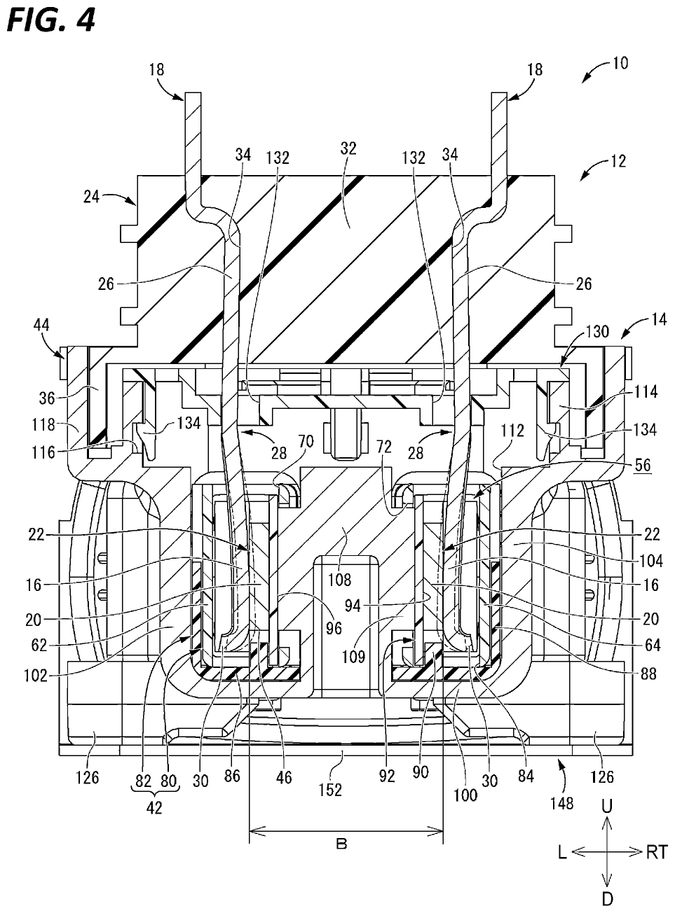

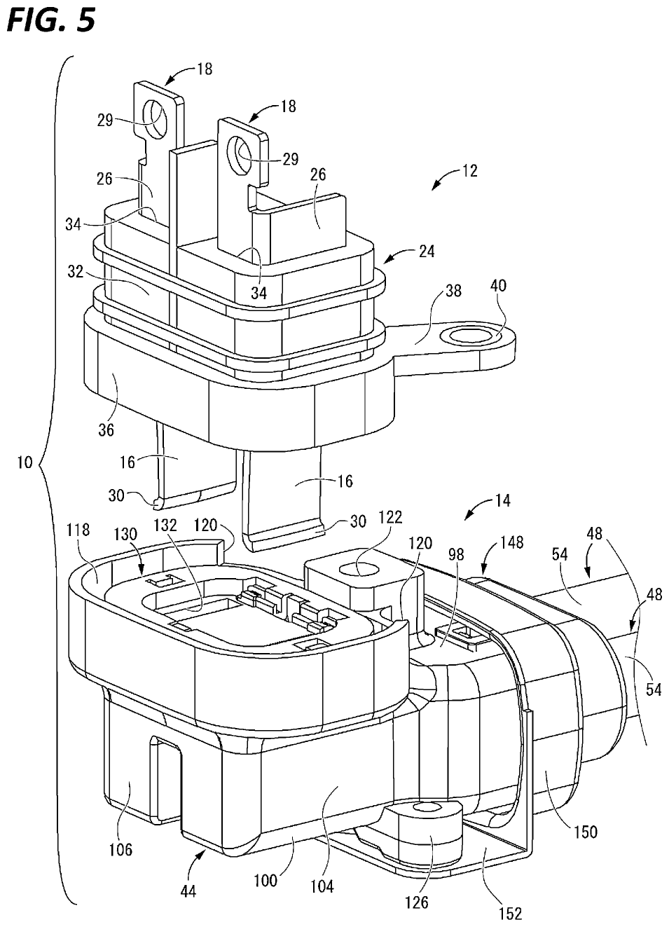

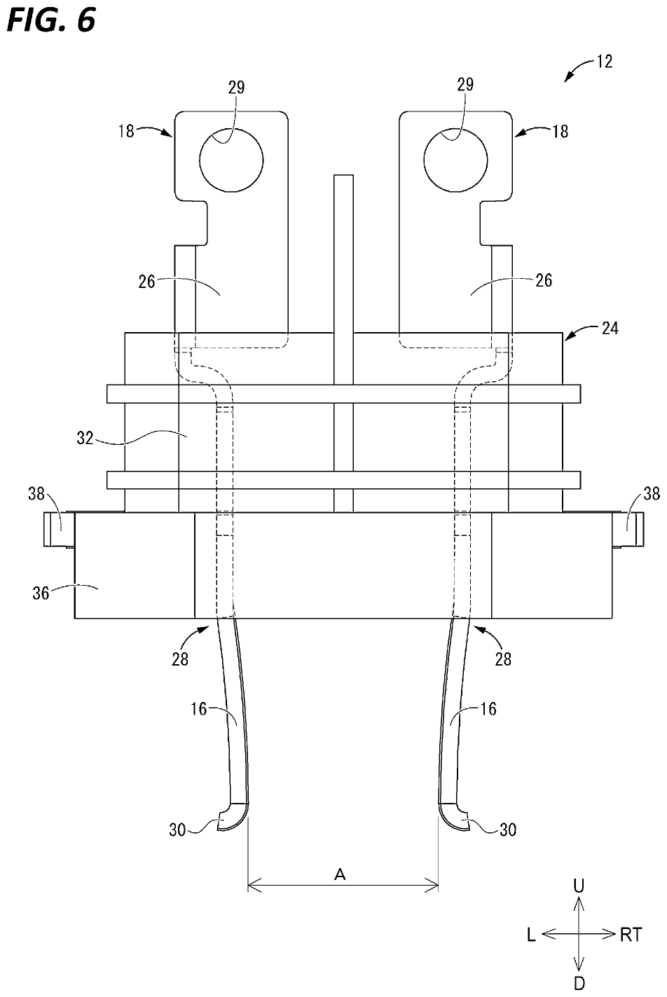

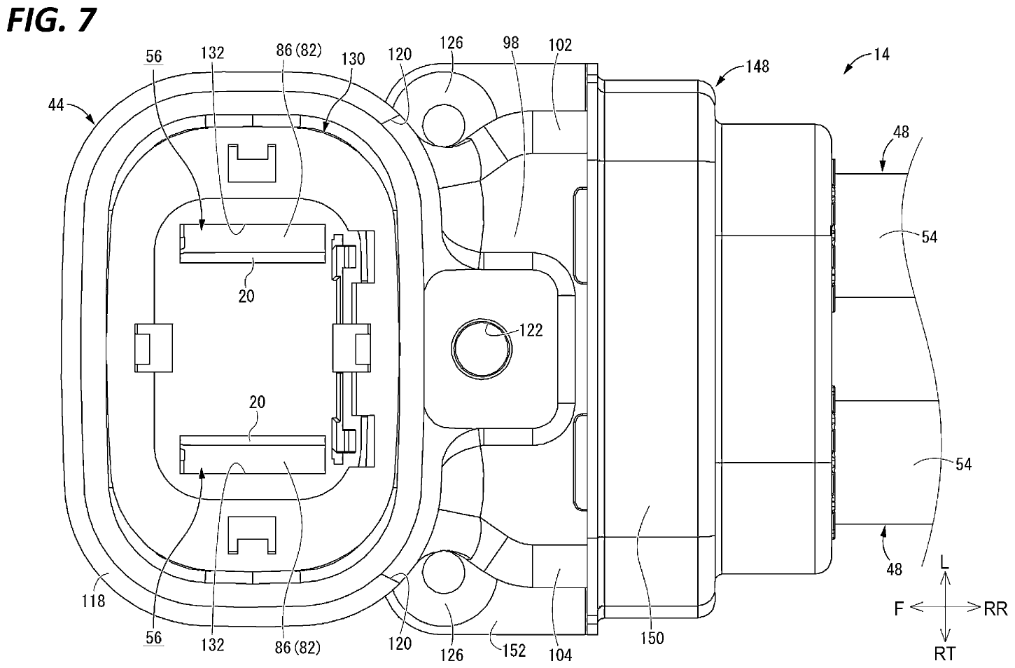

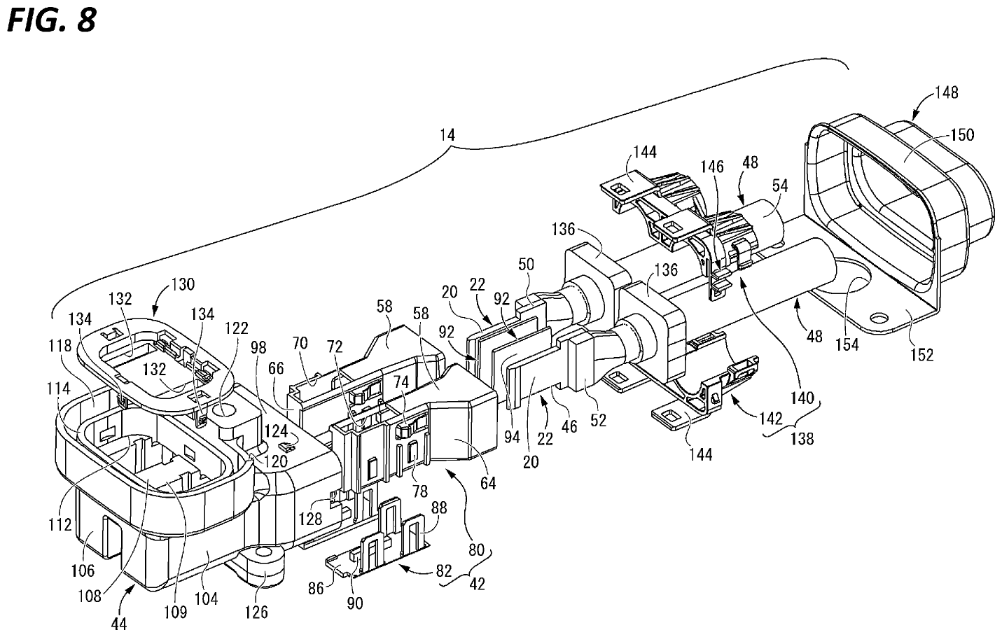

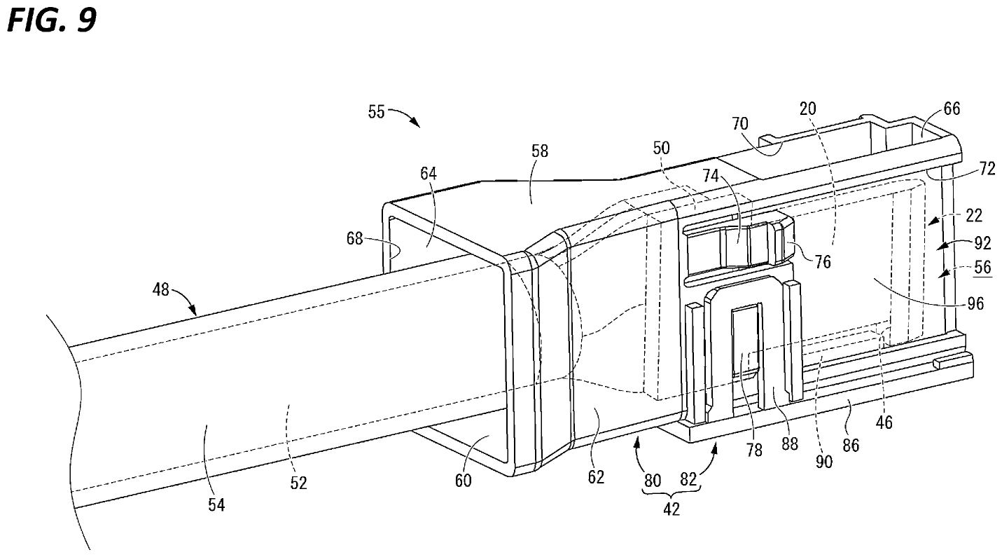

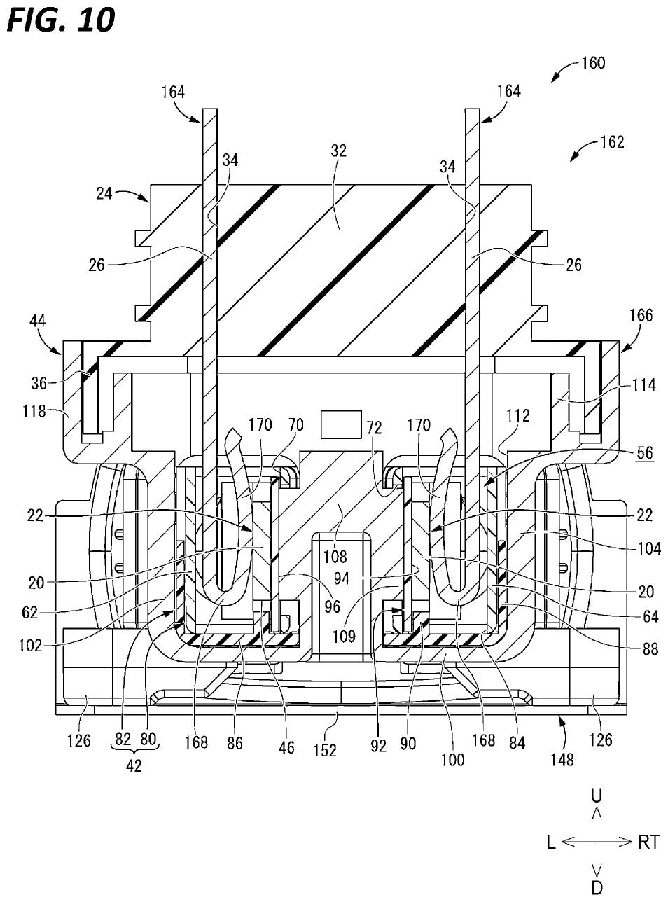

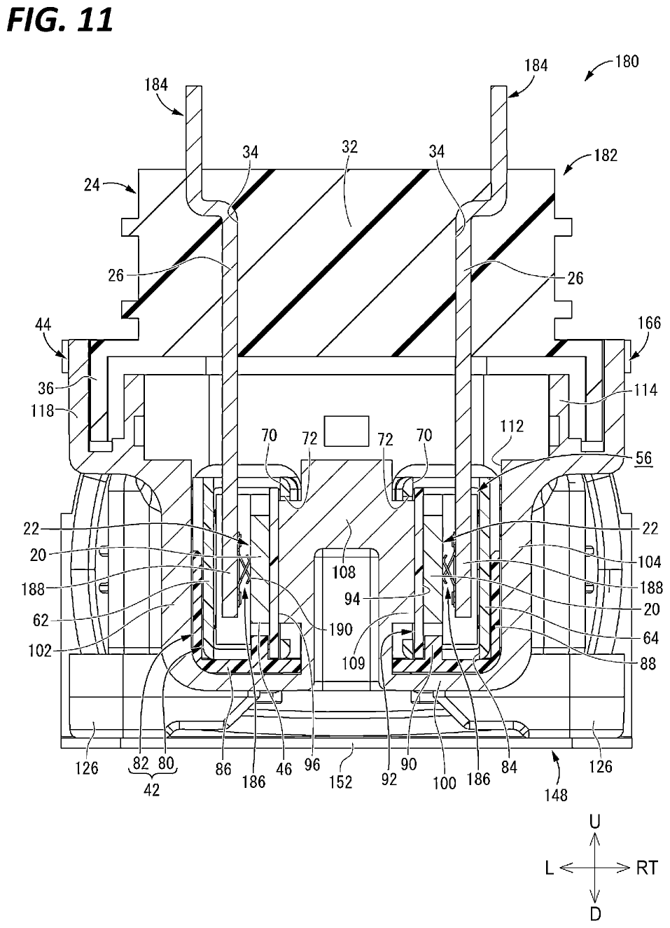

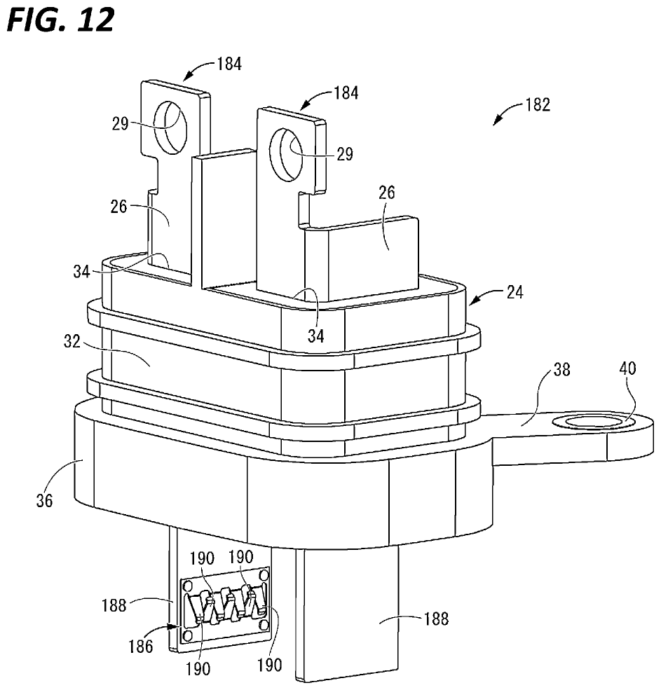

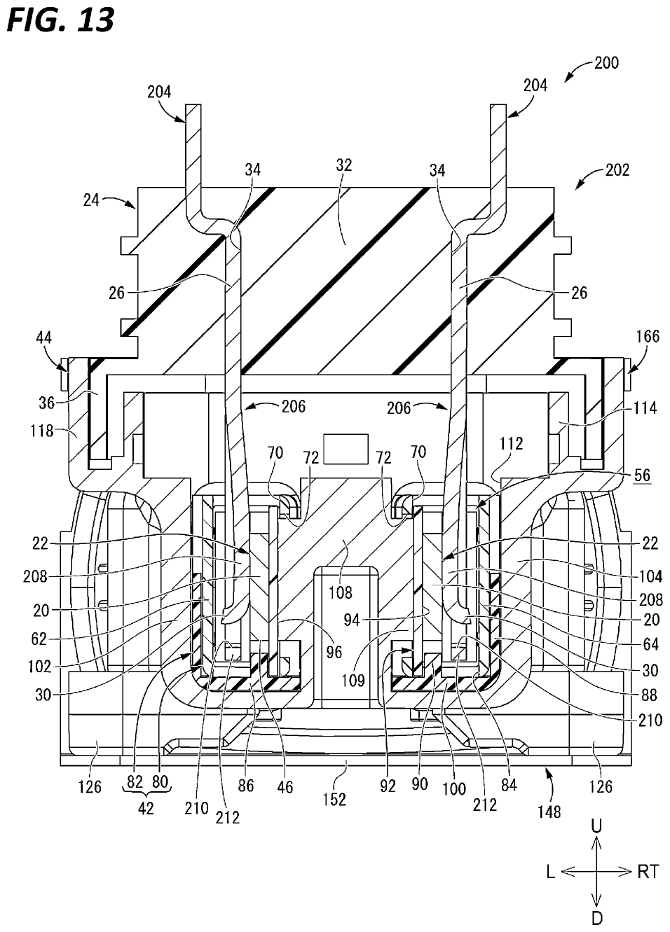

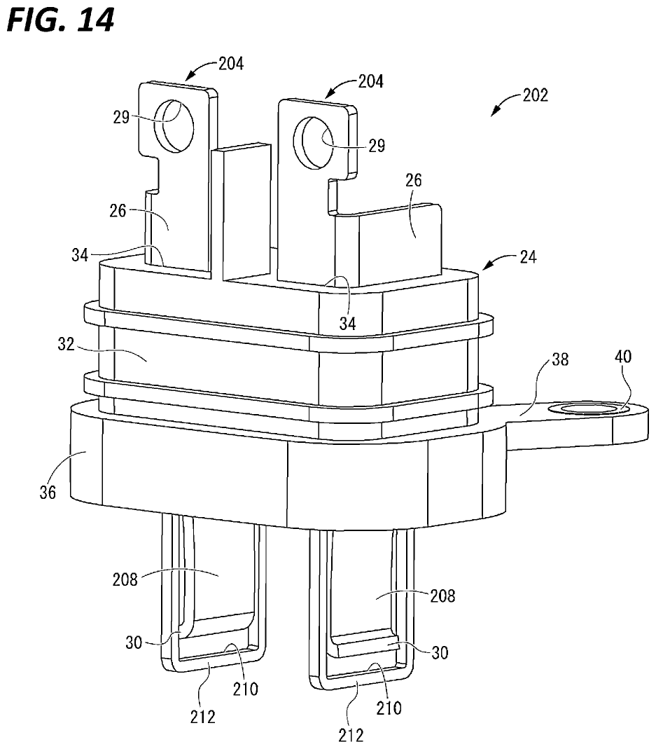

FIG. 10 is a transverse section, corresponding to FIG. 4, showing a connector unit according to a second embodiment.

FIG. 11 is a transverse section, corresponding to FIG. 4, showing a connector unit according to a third embodiment.

FIG. 12 is a perspective view showing a first connector constituting the connector unit shown in FIG. 11.

FIG. 13 is a transverse section, corresponding to FIG. 4, showing a connector unit according to a fourth embodiment.

FIG. 14 is a perspective view showing a first connector constituting the connector unit shown in FIG. 13.

### DETAILED DESCRIPTION TO EXECUTE THE INVENTION

### Description of Embodiments of Present Disclosure

First, embodiments of the present disclosure are listed and described.

(1) The connector unit of the present disclosure includes a first connector and a second connector, the first connector including an insulating terminal block and a first terminal fitting, the first terminal fitting including a base end portion held in the terminal block and a first connecting portion provided on a tip side projecting from the terminal block, the second connector including a second terminal fitting having a second connecting portion to be connected to the first connecting portion, an insulating housing for accommodating the second terminal fitting and a shield shell for covering an outer surface of the housing, the housing including an insertion hole, the first connecting portion being inserted and arranged in the insertion hole, the second connecting portion being arranged to be contactable with the first connecting portion in the insertion hole, the first terminal fitting integrally including a resilient deforming portion for resiliently deforming the first connecting portion in a direction separating from the second connecting portion as contacting the second connecting portion, and the first connecting portion being pressed against the second connecting portion and the second connecting portion being pressed against the shield shell via an insulating member by a resilient restoring force of the resilient deforming portion.

According to the connector unit of the present disclosure, the first terminal fitting integrally includes the resilient deforming portion instead of an insulating resin portion molded to fill a gap between a shield shell of a second connector and a second terminal fitting in a conventional structure, and the first connecting portion of the first terminal fitting is pressed against the second connecting portion of the second terminal fitting and the second connecting portion is pressed against the shield shell via the insulating member by the resilient restoring force of the resilient deforming portion. In this way, a contact part of the first and second connecting portions having a largest heat generation amount in the connector unit can be stably pressed against the shield shell. Thus, a shorter heat dissipation path than in the conventional structure can be constructed, and the heat dissipation performance of the connector unit can be improved. Moreover, since the insulating resin portion filled to fill up an air layer in the shield shell by insert molding is not used unlike the conventional structure, a possibility of varying the heat dissipation performance of the connector unit due to the occurrence of short shots or voids is also reduced.

Note that the second connecting portion only has to be pressed against the shield shell via the insulating member, and the insulating member may be the housing or a member having a higher thermal conductivity than the housing.

(2) Preferably, the first terminal fitting integrally includes a bent portion for displacing the first connecting portion toward the second connecting portion with respect to the base end portion, the resilient deforming portion being constituted by the bent portion, the bent portion is resiliently deformed by contact of the first and second connecting portions, and the first connecting portion is pressed against the second connecting portion and the second connecting portion is pressed against the shield shell via the insulating member by a resilient restoring force of the bent portion. Since a pressing force of the first connecting portion toward the second connecting portion and the shield shell is exerted by the bent portion integrally provided in the first terminal fitting, a separate spring member is not necessary and a reduction in the number of components and the size reduction of the connector unit are achieved.

(3) Preferably, the insulating member includes a heat dissipating member having a higher thermal conductivity than the housing, the heat dissipating member has a connecting portion side contact surface to be held in contact with the second connecting portion and a shell side contact surface to be held in contact with the shield shell by being exposed from an opening of the housing, and the second connecting portion pressed by the first connecting portion is pressed against the shield shell via the heat dissipating member by the resilient restoring force of the resilient deforming portion. Since the second connecting portion pressed by the first connecting portion due to the resilient restoring force of the resilient deforming portion is pressed against the shield shell via the heat dissipating member having a higher thermal conductivity than the housing, the heat dissipation performance of the connector unit can be further improved by suppressing a reduction in the heat dissipation efficiency of the housing.

(4) Preferably, in (2) described above, the first terminal fitting is constituted by a busbar and the bent portion is provided by bending or curving one place in a longitudinal direction of the busbar in a plate thickness direction. The bent portion of the first terminal fitting can be easily formed, utilizing one busbar, and the structural simplification and the size reduction of the first terminal fitting and the entire connector unit can be advantageously achieved.

(5) Preferably, in (4) described above, the bent portion is provided by bending a part between the base end portion and the first connecting portion in the longitudinal direction of the busbar in the plate thickness direction. The bent portion can be easily formed only by bending the part located between the base end portion and the first connecting portion in the longitudinal direction of the busbar in the plate thickness direction, and further structural simplification and further size reduction of the first terminal fitting and the entire connector unit can be achieved.

(6) Preferably, in (4) or (5) described above, a tip curved portion inclined in a direction opposite to the bent portion in the plate thickness direction of the busbar is provided on a tip part of the busbar. Since the tip curved portion is provided on the tip part of the busbar, the collision of the tip part of the busbar with the housing of the second connector and the like can be advantageously suppressed at the time of connecting the first and second connectors. Further, since the tip curved portion is inclined in the direction opposite to the bent portion, the bent portion can be advantageously resiliently deformed in the direction (direction separating from the second connecting portion) opposite to a bending direction of the bent portion when the tip curved portion of the busbar contacts and slides on the second connecting portion of the second terminal fitting.

(7) Preferably, in (4) described above, the first connecting portion is formed by cutting and raising a widthwise intermediate part of the busbar into a cantilever shape over a predetermined dimension in one place in the longitudinal direction of the busbar, and the bent portion is constituted by a coupling portion of the first connecting portion to the busbar. Since the first connecting portion can be formed by cutting and raising the widthwise intermediate part of the busbar into a cantilever shape and the coupling portion of the first connecting portion to the busbar serves as the bent portion when the busbar is cut and raised, the first connecting portion and the bent portion can be efficiently manufactured. Further, cutting and raising range and directions can be changed according to a configuration on the second connector side, and a degree of freedom in designing the connector unit can also be improved.

(8) Preferably, in (4) described above, the bent portion is provided to be curved in the plate thickness direction by curvedly folding a part on the tip side in the longitudinal direction of the busbar toward the second connecting portion, and the first connecting portion is constituted by a part folded toward the second connecting portion in the busbar. Since the bent portion is provided by curvedly folding the part on the tip side in the longitudinal direction of the busbar, a wide region of the bent portion can be ensured and a degree of freedom in designing the pressing force can be improved.

(9) Preferably, the first connector includes a pair of the first terminal fittings, the second connector includes a pair of the second terminal fittings, one second connecting portion and the other second connecting portion of the pair of second terminal fittings are arranged to face each other across a wall portion of the shield shell, one insertion hole and the other insertion hole are arranged on both sides in a facing direction of the one and the other second connecting portions across the wall portion of the shield shell, and one first connecting portion and the other first connecting portion of the pair of first terminal fittings respectively inserted in the one and the other insertion holes are pressed in directions approaching each other by resilient restoring forces of the respective resilient deforming portions.

If each of the first and second connectors includes the pair of first/second terminal fittings, the second connecting portions and the first connecting portions can be successively pressed across the wall portion of the shield shell by the resilient restoring forces of the resilient deforming portions of the respective first terminal fittings. By this configuration, a heat dissipation path utilizing the common wall portion of the shield shell can be constructed, and the compact connector unit excellent in heat dissipation performance can be provided with good space efficiency.

### Details of Embodiments of Present Disclosure

Specific examples of a connector unit of the present disclosure are described below with reference to the drawings. Note that the present disclosure is not limited to these illustrations, but is represented by claims and intended to include all changes in the scope of claims and in the meaning and scope of equivalents.

### First Embodiment

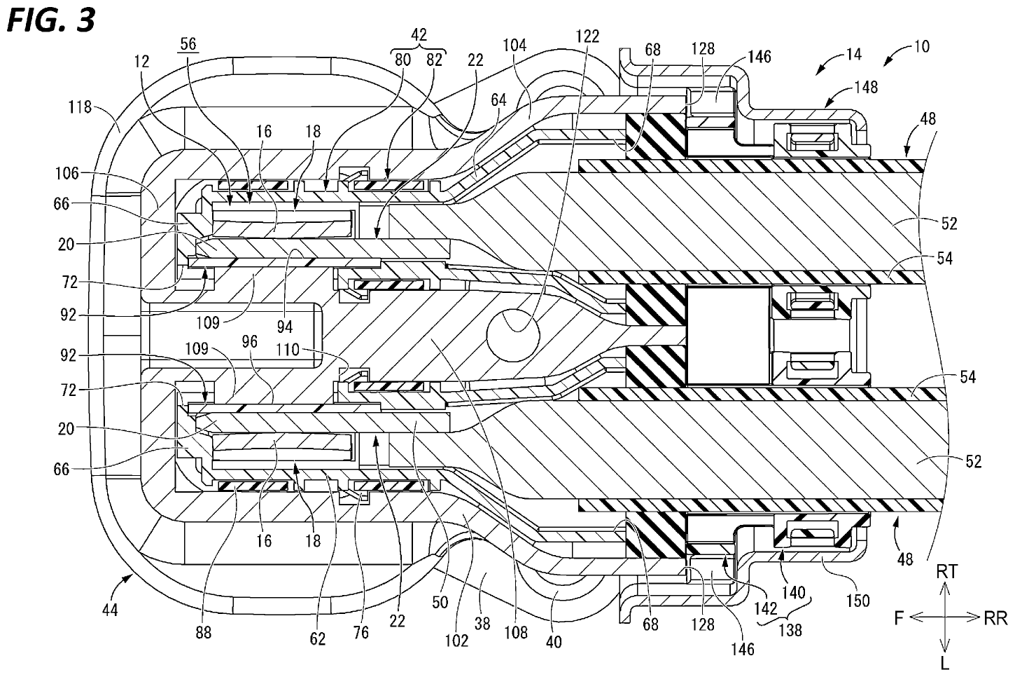

Hereinafter, a connector unit 10 of a first embodiment of the present disclosure is described using FIGS. 1 to 9. The connector unit 10 includes a first connector 12 and a second connector 14 to be detachably connected to the first connector 12. The first connector 12 is provided with first terminal fittings 18 each including a first connecting portion 16, and the second connector 14 is provided with second terminal fittings 22 each including a second connecting portion 20. By connecting the first and second connectors 12, 14, the first connecting portions 16 in the first connector 12 and the second connecting portions 20 in the second connector 14 directly or indirectly contact to be electrically conductive. Note that the connector unit 10 can be arranged in an arbitrary orientation, but upper and lower sides in FIG. 2 are referred to as upper and lower sides, left and right sides in FIG. 2 are referred to as front and rear sides and lower and upper sides in FIG. 3 are referred to as left and right sides in the following description. Further, for a plurality of identical members, only some members may be denoted by a reference sign and the other members may not be denoted by the reference sign.

### (First Connector 12)

As shown in FIG. 6 and the like, the first connector 12 is provided with a terminal block 24 made of insulating synthetic resin and the first terminal fittings 18. In the first embodiment, a pair of the first terminal fittings 18, 18 (first connecting portions 16, 16) are provided in the first connector 12, and the respective first terminal fittings 18 (first connecting portions 16) are arranged apart from each other in a lateral direction. Further, in the first embodiment, the terminal block 24 is molded with the respective first terminal fittings 18 set in a molding cavity during molding, and the terminal block 24 is formed as an integrally molded article provided with the respective first terminal fittings 18.

### (First Terminal Fittings 18)

Each first terminal fitting 18 includes a base end portion 26 held in the terminal block 24 and the first connecting portion 16 projecting toward a tip side (downward) from the terminal block 24. Further, each first terminal fitting 18 integrally includes a resilient deforming portion for resiliently deforming the first connecting portion 16 in a direction separating from the second connecting portion 20 as contacting the second connecting portion 20. In the first embodiment, each first terminal fitting 18 integrally includes a bent portion 28 for displacing the first connecting portion 16 toward the second connecting portion 20 with respect to the base end portion 26, i.e. laterally inward as described above, and each resilient deforming portion is constituted by the bent portion 28. Note that a state of each bent portion 28 before resilient deformation is shown by a two-dot chain line in FIG. 4. In a resiliently deformed state of each bent portion 28, the first connecting portion 16 is located more in the direction separating from the second connecting portion 20 (laterally outward) than before each bent portion 28 is resiliently deformed. Further, in FIG. 6, each first terminal fitting 18 is shown in the state before the bent portion 28 is resiliently deformed.

Note that each first connecting portion 16 only has to be located (displaced) laterally inward of a part adjacent to a base end side (upper side) with respect to the bent portion 28 by the bent portion 28. For example, if a base end part of each first terminal fitting 18 includes a part spreading in the lateral direction as shown in FIG. 6, each first connecting portion 16 may be located laterally outward of a part located most laterally inward in the base end part of the first terminal fitting 18. Further, a bolt insertion hole 29 is provided in a part spreading in the lateral direction in the base end part of each first terminal fitting 18, and each first terminal fitting 18 is fixed to a terminal portion of an unillustrated device or the like by a bolt inserted through the bolt insertion hole 29. Note that each first terminal fitting 18 may not be provided with the bolt insertion hole 29, and each first terminal fitting may be fixed to the unillustrated device or the like by crimping or fixing a base end part of the first terminal fitting to a wire of the device.

Specifically, each first terminal fitting 18 is, for example, constituted by a busbar formed, such as by press-working a metal flat plate into a predetermined shape, and each bent portion 28 is provided by bending or curving one place in a longitudinal direction (vertical direction) of the busbar in a plate thickness direction (lateral direction). In the first embodiment, each bent portion 28 is provided by bending a part between the base end portion 26 and the first connecting portion 16 in the longitudinal direction (vertical direction) of the busbar in the plate thickness direction (lateral direction).

That is, in the first embodiment, a longitudinally intermediate part of each first terminal fitting 18 is fixed by being embedded in the terminal block 24 over a predetermined region, and a tip part (lower end part) and the base end part (upper end part) of each first terminal fitting 18 project toward both vertical sides from a later-described terminal holding portion 32 of the terminal block 24. The base end portion 26 of each first terminal fitting 18 to be held in the terminal block 24 is constituted by a part non-displaceable by being fixed to the terminal block 24 in the first terminal fitting 18. Further, the bent portion 28 is provided in the intermediate part in the longitudinal direction (vertical direction) of each first terminal fitting 18, and each first terminal fitting 18 is resiliently deformable at the bent portion 28. In each first terminal fitting 18, a side closer to the tip (lower side) than the bent portion 28 is the first connecting portion 16, and the first connecting portion 16 is located closer to the second connecting portion 20 (more laterally inward) than a part adjacent to the base end side with respect to the bent portion 28 by being bent at the bent portion 28 in each first terminal fitting 18.

Further, a tip part (lower end part) of each busbar (each first terminal fitting 18) is provided with a tip curved portion 30 inclined while being curved in a direction opposite to the bent portion 28 (laterally outward) in the plate thickness direction (lateral direction) of the busbar.

### (Terminal Block 24)

The terminal block 24 includes the terminal holding portion 32 substantially in the form of a rectangular block as a whole, and terminal insertion holes 34, through which the first terminal fittings 18 are inserted, are provided to penetrate through the terminal holding portion 32 in the vertical direction. Since the pair of first terminal fittings 18, 18 are provided apart from each other in the lateral direction in the first embodiment, a pair of the terminal insertion holes 34, 34 are provided apart from each other in the lateral direction in the terminal holding portion 32.

Further, a receptacle 36 projecting downward is provided on an outer peripheral edge part of a tip side (lower side) of the terminal block 24. As also shown in FIG. 5 and the like, the receptacle 36 has a substantially oval shape with a dimension in the lateral direction larger than a dimension in a front-rear direction in a plan view (projection in the vertical direction). That is, a part of each first terminal fitting 18 projecting toward the tip side from the terminal holding portion 32 is located on an inner peripheral side of the receptacle 36. Further, in an upper end part of the receptacle 36, fixing pieces 38, 38 projecting rearward are provided on both sides in the lateral direction. Each fixing piece 38 projects in a direction inclined laterally outward toward a rear side, and a collar 40, into which an unillustrated bolt is inserted, is fixed in an embedded state in a projecting end part (rear end part) of each fixing piece 38. The first connector 12 can be, for example, fixed to a case of the unillustrated device by the bolts inserted into these collars 40.

### (Second Connector 14)

The second connector 14 is provided with the second terminal fittings 22 each including the second connecting portion 20 to be connected to the first connecting portion 16, insulating housings 42 for accommodating the second terminal fittings 22 and a shield shell 44 for covering the outer surfaces of the housings 42. Since the pair of first connecting portions 16, 16 are provided in the first embodiment, a pair of the second terminal fittings 22, 22 (second connecting portions 20, 20) and a pair of the housings 42, 42 are provided in the second connector 14. The respective second terminal fittings 22 (second connecting portions 20) and the respective housings 42 are arranged apart from each other in the lateral direction.

### (Second Terminal Fittings 22)

The respective second terminal fittings 22 have the same shape. Each second terminal fitting 22 is a member substantially in the form of a rectangular plate spreading in the front-rear direction as a whole as also shown in FIGS. 3 and 8, and has a dimension in the lateral direction gradually reduced toward a tip side (front side). Further, a positioning recess 46 open downward and penetrating in a plate thickness direction (lateral direction) is formed in an intermediate part in the front-rear direction of each second terminal fitting 22. A base end part (rear end part) of each second terminal fitting 22 has a larger dimension in the vertical direction than other parts, and the base end part of each second terminal fitting 22 serves as a wire fixing portion 50 to be fixed to a coated wire 48. In each second terminal fitting 22 shaped as just described, as shown in FIGS. 3 and 4, the intermediate part in the front-rear direction where the positioning recess 46 is formed is the second connecting portion 20 to be connected to the first connecting portion 16 at the time of connecting the first and second connectors 12, 14.

Each coated wire 48 is composed of a core wire 52 and an insulation coating 54 made of synthetic resin and covering the core wire 52 substantially over an entire length. The insulation coating 54 is stripped to expose the core wire 52 in an end of each coated wire 48, and the exposed core wire 52 is fixed to the wire fixing portion 50 of each second terminal fitting 22, whereby each second terminal fitting 22 and each coated wire 48 are connected. Note that a fixing method of each wire fixing portion 50 and each core wire 52 is not limited, and each wire fixing portion 50 and each core wire 52 may be fixed by adhesion, welding, crimping using a crimping piece or the like.

### (Housings 42)

Since the pair of housings 42, 42 separated from each other in the lateral direction are bilaterally symmetrically shaped, the right housing 42 shown in FIG. 9 is described below. In FIG. 9, the second terminal fitting 22 fixed to the coated wire 48 at the wire fixing portion 50 is shown as a housing side assembly 55 in a state accommodated in the housing 42. As also shown in FIG. 9, the housing 42 includes a terminal accommodating portion 56 substantially in the form of a rectangular tube for accommodating a front end part of the coated wire 48 and the second terminal fitting 22. That is, the housing 42 includes an upper wall portion 58 constituting a wall portion on an upper side of the terminal accommodating portion 56, a lower wall portion 60 constituting a wall portion on a lower side, a left wall portion 62 constituting a wall portion on a left side and a right wall portion 64 constituting a wall portion on a right side. The terminal accommodating portion 56 is closed from front by a front wall portion 66, and the coated wire 48 accommodated in the terminal accommodating portion 56 is pulled out to an outside space through a rear opening 68 of the terminal accommodating portion 56.

An insertion hole 70 penetrating in the vertical direction is formed in a front part of the upper wall portion 58 in this housing 42. This insertion hole 70 is provided over a predetermined region in the front part of the upper wall portion 58, and the first connecting portion 16 is inserted and arranged in the insertion hole 70 at the time of connecting the first and second connectors 12, 14. That is, the terminal accommodating portion 56 communicates with the outside space through the insertion hole 70, and the second connecting portion 20 is arranged to be able to contact the first connecting portion 16 in a front part of the terminal accommodating portion 56 communicating with outside through the insertion hole 70.

Further, a side window portion 72 serving as an opening penetrating in a thickness direction (lateral direction) is formed in a front part of the left wall portion 62 in the housing 42. The side window portion 72 is formed substantially over the entire length in the vertical direction of the left wall portion 62, and formed with a predetermined dimension in the front-rear direction from a front end part (front wall portion 66) of the left wall portion 62. In the first embodiment, the side window portion 72 is formed from the front end part to an intermediate part in the front-rear direction of the left wall portion 62. In this way, the terminal accommodating portion 56 communicates with the outside space through the side window portion 72. Further, a resilient piece 74 projecting forward and resiliently deformable in the lateral direction is provided in an upper part of a part (intermediate part in the front-rear direction of the left wall portion 62) of the left wall portion 62 behind the side window portion 72. A locking claw 76 projecting leftward is provided on a projecting tip part (front end part) of this resilient piece 74. A lock protrusion 78 to be engaged with a lock frame body 88 in a terminal fixing portion 82 to be described later is provided below the resilient piece 74 on the left wall portion 62.

A resilient piece 74 including a locking claw 76 and a lock protrusion 78 are also provided in an intermediate part in the front-rear direction of the right wall portion 64 in the housing 42. The resilient piece 74 and the lock protrusion 78 on the right wall portion 64 are located substantially at the same position in the front-rear direction as those of the left wall portion 62, the resilient piece 74 including the locking claw 76 is provided in an upper part of the intermediate part in the front-rear direction of the right wall portion 64 and the lock protrusion 78 is provided in a lower part. Further, the right wall portion 64 is provided with another lock protrusion 78 in a lower part of a front part.

Note that since the pair of housings 42, 42 are bilaterally symmetrically shaped as described above, the right wall portion 64 is provided with a side window portion 72, a resilient piece 74 and a lock protrusion 78 in the left housing 42. Further, the left wall portion 62 is provided with a resilient piece 74 and a pair of the lock protrusions 78, 78.

In the first embodiment, each housing 42 is composed of a housing body 80 and the terminal fixing portion 82 to be assembled with the housing body 80 from below as also shown in FIGS. 8, 9 and the like. That is, the housing body 80 is configured to include the upper, lower, left, right and front wall portions 58, 60, 62, 64 and 66, a lower window portion 84 (see FIG. 4) penetrating in the vertical direction is provided in a front part of the lower wall portion 60, and the terminal fixing portion 82 is assembled to cover this lower window portion 84. In short, the terminal accommodating portion 56 in the housing body 80 communicates with the outside space through the lower window portion 84 and the lower window portion 84 is closed by assembling the terminal fixing portion 82 with the housing body 80. In this way, a part of the wall portion on the lower side in the housing 42 is constituted by the terminal fixing portion 82. Note that a pair of the terminal fixing portions 82 are provided in the lateral direction. Since the respective terminal fixing portions 82 are bilaterally symmetrically shaped, the right terminal fixing portion 82 is described below using FIGS. 8 and 9.

The terminal fixing portion 82 is provided with a base plate portion 86 sized to be able to cover the lower window portion 84, and the lock frame bodies 88 projecting upward are provided on outer end parts in the lateral direction of the base plate portion 86. These lock frame bodies 88 are provided at positions corresponding to the respective lock protrusions 78 on the housing body 80, a pair of the lock frame bodies 88, 88 are provided apart from each other in the front-rear direction on a right end part of the terminal fixing portion 82, and one lock frame body 88 is provided on a rear part of a left end part of the terminal fixing portion 82.

Further, in an intermediate part in the front-rear direction of the base plate portion 86, a positioning protrusion 90 projecting upward is provided at a position separated rightward from the left end part by a predetermined distance. This positioning protrusion 90 is provided at a position deviated slightly leftward with respect to a lateral center of the base plate portion 86 and has a predetermined dimension in the front-rear direction. As shown in FIG. 9, the positioning protrusion 90 enters the positioning recess 46 provided in the lower part of the second terminal fitting 22 from below when the second terminal fitting 22 is mounted into the housing 42. In this way, the second terminal fitting 22 is positioned in the front-rear direction with respect to the housing 42 and the detachment of the second terminal fitting 22 through the rear opening 66 in the housing 42 is prevented.

Note that, as described above, the pair of terminal fixing portions 82, 82 are bilaterally symmetrically shaped. Thus, in the left terminal fixing portion 82, one lock frame body 88 is provided on a right end part and a pair of lock frame bodies 88, 88 are provided on a left end part. Further, in an intermediate part in the front-rear direction of a base plate portion 86, a positioning protrusion 90 projecting upward is provided at a position deviated slightly rightward from a lateral center.

### (Insulating Member (Heat Dissipating Member 92))

As also shown in FIGS. 8 and 9, not only the second terminal fitting 22, but also an insulating member having an insulating property is accommodated in each housing 42 composed of the housing body 80 and the terminal fixing portion 82. In the first embodiment, the insulating member is constituted by a heat dissipating member 92 having a higher thermal conductivity than the housing 42. A material of the heat dissipating member 92 is not limited as long as the thermal conductivity is higher than that of the housing 42. In the first embodiment, ceramic is adopted. Note that the heat dissipating members 92 to be respectively accommodated into the respective housings 42 have the same shape and are substantially in the form of rectangular plates. Each of these heat dissipating members 92 is sized to be able to cover the side window portion 72 in each housing 42.

Each heat dissipating member 92 is accommodated laterally inward of the second terminal fitting 22 in the housing 42. That is, in the right housing 42 shown in FIG. 9, the heat dissipating member 92 is accommodated between the second terminal fitting 22 and the left wall portion 62 in the lateral direction. Specifically, the heat dissipating member 92 is arranged between the positioning protrusion 90 in the terminal fixing portion 82 and the left wall portion 62 of the housing body 80 in the lateral direction, whereby the side window portion 72 provided in the left wall portion 62 is covered by the heat dissipating member 92. In other words, the laterally inner surface of each heat dissipating member 92 is exposed to the outside space through the side window portion 72 with each heat dissipating member 92 assembled with the housing 42.

Each of these heat dissipating members 92 is interposed between the second connecting portion 20 and the shield shell 44 when the first connecting portion 16 is pressed against the second connecting portion 20 by a resilient restoring force of the bent portion 28 serving as the resilient deforming portion at the time of connecting the first and second connectors 12, 14 as described later. In short, each first connecting portion 16 is pressed against the second connecting portion 20, whereby the second connecting portion 20 is pressed against the shield shell 44 via the heat dissipating member 92. That is, as also shown in FIGS. 3 and 4, the laterally outer surface of each heat dissipating member 92 is a connecting portion side contact surface 94 to be held in contact with the second connecting portion 20, and the laterally inner surface is a shell side contact surface 96 to be held in contact with the shield shell 44 by being exposed from the side window portion 72 of the housing 42.

### (Shield Shell 44)

The shield shell 44 is shaped to cover the pair of housings 42, 42 substantially entirely and made of metal good in thermal conduction efficiency. That is, the shield shell 44 includes an upper wall portion 98 for covering the respective housings 42 from above, a lower wall portion 100 for covering the respective housings 42 from below, a left wall portion 102 for covering the left housing 42 from left, a right wall portion for covering the right housing 42 from right and a front wall portion 106 for covering the respective housings 42 from front. Further, a partitioning portion 108 partitioning an internal space of the shield shell 44 in the lateral direction is provided between the respective housings 42 in the lateral direction inside the shield shell 44. Contact portions 109 projecting laterally outward and to be held in contact with the shell side contact surfaces 96 of the respective heat dissipating members 92 as described later are provided in a front part of this partitioning portion 108. Further, as shown in FIGS. 3 and 8, locking recesses 110 engageable with the respective locking claws 76 in the respective housings 42 are formed in the inner surfaces of the left wall portion 102, the right wall portion 104 and the partitioning portion 108.

Further, a through hole 112 penetrating through the upper wall portion 98 in the vertical direction is formed in a front part of the upper wall portion 98 of the shield shell 44. This through hole 112 has a substantially oval shape with a dimension in the lateral direction larger than a dimension in the front-rear direction and provided over the respective housings 42 separated from each other in the lateral direction. An inner tube portion 114 projecting upward is provided on a peripheral edge part of this through hole 112, and a front retainer 130 to be described later is mounted into this inner tube portion 114. Note that lock recesses 116 are provided at a plurality of positions on a circumference in the inner peripheral surface of the inner tube portion 114, and the respective lock recesses 116 are engaged with lock protrusions 134 provided on the front retainer 130, whereby the front retainer 130 is fixed to the inner tube portion 114.

Further, an outer tube portion 118 projecting further upward than the inner tube portion 114 is provided on an outer peripheral side of the inner tube portion 114 in the upper wall portion 98. This outer tube portion 118 has a substantially oval shape with a dimension in the lateral direction larger than a dimension in the front-rear direction in a plan view and is shaped to substantially correspond to the receptacle 36 in the first connector 12. Further, as shown in FIG. 4, the receptacle 36 in the first connector 12 enters between the inner tube portion 114 and the outer tube portion 118 of the shield shell 44 in a radial direction at the time of connecting the first and second connectors 12, 14. Note that cut portions 120, 120, into which the respective fixing pieces 38 projecting rearward from the receptacle 36 are inserted, are formed on left and right sides in a rear part of the outer tube portion 118. In this way, at the time of connecting the first and second connectors 12, 14, the connection of the first and second connectors 12, 14 is guided by the insertion of the receptacle 36 into the outer tube portion 118 and the insertion of the respective fixing pieces 38 into the respective cut portions 120.

Note that a bolt insertion hole 122 penetrating in the vertical direction is formed in a part behind the outer tube portion 118 in the partitioning portion 108 of the shield shell 44. An unillustrated fastening bolt is inserted into the bolt insertion hole 122, and this fastening bolt is, for example, fastened to the case or the like of the unillustrated device fixed to the first connector 12 at the time of connecting the first and second connectors 12, 14. In this way, the first and second connectors 12, 14 can be connected, utilizing a fastening force of the fastening bolt.

Further, lock claw portions 124 projecting outward in the vertical direction are provided on rear end parts of the upper wall portion 98 and the lower wall portion 100 in the shield shell 44. In the first embodiment, a pair of the lock claw portions 124, 124 are provided apart from each other in the lateral direction on each of the upper wall portion 98 and the lower wall portion 100. Further, fixing portions 126, 126 to be fixed to a shield bracket 148 to be described later are provided on both sides in the lateral direction in a lower part of the shield shell 44. In the first embodiment, a forward projecting portion 152 projecting forward from the shield bracket 148 is overlapped on the respective fixing portions 126, and the shield shell 44 and the shield bracket 148 are fixed to each other by unillustrated bolts.

Note that engaging recesses 128, 128 in the form of cuts open rearward and penetrating through the left and right wall portions 102, 104 in a thickness direction (lateral direction) are formed on both sides in the lateral direction in a rear end part of the shield shell 44. In the first embodiment, engaging protrusions 146, 146 projecting laterally outward are provided on a back retainer 138 to be described later, and the back retainer 138 is fixed to the shield shell 44 by fitting the respective engaging protrusions 146 into the respective engaging recesses 128 when the second connector 14 is assembled. Note that the respective engaging protrusions 146 are preferably press-fit into the respective engaging recesses 128.

The front retainer 130 to be mounted into the inner tube portion 114 of such a shield shell 44 has a substantially oval shape with a dimension in the lateral direction larger than a dimension in the front-rear direction in a plan view as also shown in FIGS. 7, 8 and the like. Substantially rectangular terminal insertion windows 132, through which the first connecting portions 16 in the first connector 12 are inserted, are formed to penetrate through a central part of this front retainer 130 in the vertical direction. These terminal insertion windows 132 are formed at positions corresponding to the insertion holes 70 provided in the respective housings 42 when the second connector 14 is assembled, and a pair of the terminal insertion windows 132, 132 are provided apart from each other in the lateral direction. In this way, a front part of the terminal accommodating portion 56 in each housing 42 communicates with the outside space through the insertion hole 70 in each housing 42, the through hole 112 in the shield shell 44 and the terminal insertion window 132 in the front retainer 130. Note that the lock protrusions 134 projecting downward are formed at positions corresponding to the respective lock recesses 116 in the shield shell 44 on an outer peripheral part of the front retainer 130.

An annular waterproof rubber 136 is externally fit and mounted on each coated wire 48 pulled out rearward from the rear opening 68 of each housing 42 inserted into the shield shell 44 as described above, and each waterproof rubber 136 is inserted into a rear opening in the shield shell 44. Further, the back retainer 138 for preventing the detachment of each waterproof rubber 136 is provided behind each waterproof rubber 136 on each coated wire 48.

In the first embodiment, the back retainer 138 is composed of an upper retainer 140 and a lower retainer 142, which can be assembled with each other, and the upper and lower retainers 140, 142 are assembled while sandwiching each coated wire 48 from both sides in the vertical direction behind the shield shell 44. Each of these upper and lower retainers 140, 142 is provided with a pair of lock frame bodies 144, 144 projecting forward. In this way, the back retainer 138 configured by assembling the upper and lower retainers 140, 142 is fixed behind the respective waterproof rubbers 136 by locking and fitting the respective lock claw portions 124 provided on the rear end part of the shield shell 44 and the respective lock frame bodies 144.

Particularly, in the first embodiment, the engaging protrusions 146 projecting laterally outward are provided on each of the upper and lower retainers 140, 142. By assembling these upper and lower retainers 140, 142, a pair of the engaging protrusions 146, 146 project on each of both sides in the lateral direction in the back retainer 138. Note that the upper and lower retainers 140, 142 may have the same shape and the back retainer 138 may be configured by assembling a pair of the upper retainers 140, 140 (or a pair of the lower retainers 142, 142) vertically inverted from each other.

This back retainer 138 is covered by the shield bracket 148 made of metal. The shield bracket 148 is provided with a tubular wall portion 150, and the tubular wall portion 150 covers the back retainer 138 from an outer peripheral side when the second connector 14 is assembled. This tubular wall portion 150 is provided with the forward projecting portion 152 projecting forward in a lower part, and the shield bracket 148 and the shield shell 44 are fixed to each other by overlapping the forward projecting portion 152 on the respective fixing portions 126 in the shield shell 44 as described above. A bolt insertion hole 154 is formed substantially in a central part of the forward projecting portion 152, and the bolt insertion hole 154 communicates with the bolt insertion hole 122 in the shield shell 44 and an unillustrated bolt is inserted through these bolt insertion holes 122, 154 when the second connector 14 is assembled.

### (Assembly of Connector Unit 10)

A specific example of a method for assembling the connector unit 10 by connecting the first and second connectors 12, 14 is described below. Note that the assembly method of the connector unit 10 is not limited to the one described below.

First, as described above, the respective first terminal fittings 18 formed, such as by bending a metal flat plate into a predetermined shape, and the respective collars 40 are set in the molding cavity for the terminal block 24, and the terminal block 24 is molded. In this way, the terminal block 24 provided with the respective first terminal fittings 18 and the respective collars 40 is formed as an integrally molded article, whereby the first connector 12 is completed.

Subsequently, the core wire 52 exposed by stripping the insulation coating 54 in the end of each coated wire 48 is fixed to the wire fixing portion 50 of each second terminal fitting 22. Then, each second terminal fitting 22 fixed to the heat dissipating member 92 and the coated wire 48 is inserted through the rear opening 68 of each housing body 80. Note that, as shown in FIG. 3 and the like, the front wall portion 66 and the laterally inner wall portion in each housing body 80 are formed with recesses corresponding to the heat dissipating member 92 and the second terminal fitting 22, and the heat dissipating member 92 and the second terminal fitting 22 are positioned at proper positions in each housing body 80. Thereafter, the terminal fixing portion 82 is brought closer to each housing body 80 from below, and each housing body 80 and each terminal fixing portion 82 are assembled by engaging the respective lock protrusions 78 and the respective lock frame bodies 88. In this way, each housing 42 is completed, and the second terminal fitting 22 fixed to the coated wire 48 and the heat dissipating member 92 are accommodated in each housing 42 (housing side assembly 55) as shown in FIG. 9. Note that each waterproof rubber 136 is externally fit and mounted on the coated wire 48 at an appropriate timing.

Subsequently, each housing side assembly 55 is inserted through the rear opening of the shield shell 44 and the respective locking claws 76 of each housing 42 are locked into the respective locking recesses 110 provided in the inner surface of the shield shell 44. In this way, each housing side assembly 55 is fixed to the shield shell 44. At this time, each contact portion 109 projecting laterally outward on the partitioning portion 108 of the shield shell 44 is inserted into the side window portion 72 open from the front end part on the laterally inner side of each housing 42. As a result, the shell side contact surface 96 of each heat dissipating member 92 contacts the contact portion 109 or faces the contact portion 109 across a slight separation distance. Further, each waterproof rubber 136 is inserted into the rear opening of the shield shell 44. Note that the front retainer 130 is mounted into the inner tube portion 114 of the shield shell 44 at an appropriate timing.

Thereafter, the upper and lower retainers 140, 142 are assembled from the both sides in the vertical direction to sandwich the respective coated wires 48 behind the respective waterproof rubbers 136, whereby the back retainer 138 is configured. Then, this back retainer 138 is displaced in a direction approaching the shield shell 44, whereby the respective lock frame bodies 144 are engaged with the respective lock claw portions 124 and the respective engaging protrusions 146 are fit into the respective engaging recesses 128. In this way, the back retainer 138 is fixed to the rear end part of the shield shell 44.

Subsequently, the respective coated wires 48 are inserted into the tubular wall portion 150 of the shield bracket 148 and the respective fixing portions 126 of the shield shell 44 and the forward projecting portion 152 of the shield bracket 148 are overlapped and fixed by the unillustrated bolts. In this way, the shield bracket 148 is fixed to the shield shell 44 and the second connector 14 is completed.

The completed first and second connectors 12, 14 are caused to face each other in the vertical direction as shown in FIG. 5 and brought closer to each other. In this way, as shown in FIGS. 3 and 4, the first connecting portions 16 of the respective first terminal fittings 18 are inserted into the terminal accommodating portions 56 in the respective housings 42 through the respective terminal insertion windows 132, the through hole 112 and the respective insertion holes 70. The respective first connecting portions 16 inserted into the respective terminal accommodating portions 56 contact the respective second connecting portions 20, whereby the first connector 12 and the second connector 14 are brought into a conductive state to complete the connector unit 10. Note that the insertion of each first connecting portion 16 into the terminal accommodating portion 56 may be limited, for example, by the contact of each first connecting portion 16 with the terminal fixing portion 82 constituting the wall portion on the lower side of each housing 42. Alternatively, this insertion may be limited by the contact of the lower surface of the terminal holding portion 32 in the terminal block 24 with the upper surface of the front retainer 130 or may be limited by the contact of the lower surface of the receptacle 36 in the terminal block 24 with a wall portion between the outer tube portion 118 and the inner tube portion 114 in the radial direction.

Here, a minimum dimension A (see FIG. 6) in the lateral direction between the first connecting portions 16, 16 is smaller than a distance B (see FIG. 4) between the outer surfaces of the respective second connecting portions 20, 20 in the lateral direction before the deformation of the respective bent portions 28. As a result, when each first connecting portion 16 is inserted into the terminal accommodating portion 56 in each housing 42, the inner surface of each first connecting portion 16 contacts the laterally outer surface of the second connecting portion 20 and slides while being accompanied by laterally outward resilient deformation of each bent portion 28. By a laterally inward resilient restoring force of each bent portion 28, each first connecting portion 16 is pressed against the second connecting portion 20 and each second connecting portion 20 is pressed against the contact portion 109 of the shield shell 44 via the heat dissipating member 92.

In short, as shown in FIGS. 3 and 4, the pair of second connecting portions 20, 20 are arranged to face each other in the lateral direction across the partitioning portion 108, which is a wall portion of the shield shell 44, in the second connector 14. Further, the respective insertion holes 70, 70 in the respective housings 42 are also arranged on the both sides in the lateral direction, which are both sides in a facing direction of the pair of second connecting portions 20, 20, across the partitioning portion 108. The minimum facing distance A between the respective first connecting portions 16 inserted into these insertion holes 70 is smaller than the distance B between the laterally outer surfaces of the respective second connecting portions 20. Thus, when the respective first connecting portions 16 are inserted into the terminal accommodating portions 56 in the respective housings 42, the inner surfaces of the respective first connecting portions 16 slide on the laterally outer surfaces of the respective second connecting portions 20 and the respective first connecting portions 16 are displaced in directions separating from each other by the resilient deformation of the respective bent portions 28. By the resilient restorative deformation of the respective bent portions 28, the respective first connecting portions 16 are displaced in directions approaching each other, the respective first connecting portions 16 are pressed against the respective second connecting portions 20 and the respective second connecting portions 20 are pressed against the respective contact portions 109 of the shield shell 44 via the respective heat dissipating members 92.

That is, in the connector unit 10 of the first embodiment structured as described above, each first terminal fitting 18 is provided with the bent portion 28 serving as the resilient deforming portion for resiliently deforming the first connecting portion 16 in the direction separating from the second connecting portion 20 (laterally outward) as contacting the second connecting portion 20, and each first connecting portion 16 is pressed against the second connecting portion 20 and each second connecting portion 20 is pressed against the shield shell 44 via the heat dissipating member 92 by a resilient restoring force of this bent portion 28. As a result, heat generated as each first connecting portion 16 and each second connecting portion 20 are energized is dissipated from the shield shell 44 made of metal via the heat dissipating member 92. Thus, a heat dissipation path from a contact part of each first connecting portion 16 and each second connecting portion 20 to the shield shell 44 can be set to be short and heat dissipation efficiency is improved.

Particularly, in the first embodiment, the resilient deforming portion is constituted by the bent portion 28 provided in each first terminal fitting 18. As a result, the number of components and cost are reduced as compared to the case where the resilient deforming portion is, for example, constituted by a separate spring member or the like. Further, since the stable heat dissipation path can be constructed by a simple structure as described above, the size reduction of the first and second connectors 12, 14 and, consequently, the connector unit 10 is achieved.

When each first connecting portion 16 and each second connecting portion 20 are connected, each second connecting portion 20 is pressed against the shield shell 44 via the heat dissipating member 92 having a higher thermal conductivity than the housing 42. In this way, heat can be efficiently transferred from each second connecting portion 20 to the shield shell 44 and heat dissipation efficiency from the shield shell 44 is improved.

Each first terminal fitting 18 is constituted by a busbar, and each bent part 28 is formed by bending one plate in the longitudinal direction of the busbar in the plate thickness direction. Particularly, in the first embodiment, each bent part 28 is provided by bending a part between the base end portion 26 and the first connecting portion 16 in the longitudinal direction of the busbar in the plate thickness direction (lateral direction). With such a simple structure, springiness can be given to each first terminal fitting 18, and each first connecting portion 16 can be pressed against each second connecting portion 20 at the time of connecting each first connecting portion 16 and each second connecting portion 20.

The tip curved portion 30 inclined in the direction opposite to the bent part 28 in the plate thickness direction of the busbar is provided on the tip part (lower end part) of the busbar. In this way, when being inserted into the terminal accommodating portion 56 of each housing 42 through the terminal insertion window 132, the through hole 112 and the insertion hole 70, each first connecting portion 16 is prevented from being caught by the front retainer 130, the housing 42 or the like to have the insertion thereof hindered. Further, the lower surface of each tip curved portion 30 and the upper end part of each second connecting portion 20 contact first, whereby each first connecting portion 16 can be guided laterally outward and smooth insertion of each first connecting portion 16 into the terminal accommodating portion 56 can be realized.

In the first embodiment, the pair of first connecting portions 16, 16 are provided, the pair of second connecting portions 20, 20 are provided, the inner surface of each first connecting portion 16 slides on the laterally outer surface of the second connecting portion 20 when each first connecting portion 16 is inserted into the terminal accommodating portion 56 of each housing 42. That is, the respective first connecting portions 16 are displaced to be pushed wider apart from each other by the laterally outer surfaces of the respective second connecting portions 20, and the respective second connecting portions 20 can be pressed to be sandwiched in the lateral direction by the respective first connecting portions 16 due to the resilient restoring forces of the respective bent parts 28. In this way, the respective second connecting portions 20 can be pressed against the partitioning portion 108 of the shield shell 44 located therebetween, and the connector unit 10 can be provided which has a short heat dissipation path, i.e. good heat dissipation efficiency, utilizing the pair of first connecting portions 16, 16 and the pair of second connecting portions 20, 20 well.

### Second Embodiment

Next, a connector unit 160 of a second embodiment of the present disclosure is described using FIG. 10. The connector unit 160 of the second embodiment basically has a similar structure to the connector unit 10 of the first embodiment, but the shape of each first terminal fitting 164 in a first connector 162 is different. Further, a second connector 166 also has a similar structure to the second connector 14 of the first embodiment, but differs from the second connector 14 in that the front retainer 130 is not provided. Note that, in the following description, points of difference from the first embodiment are described, and substantially the same members and parts as those of the first embodiment are denoted by the same reference signs as in the first embodiment in FIG. 10 and not described in detail.

Each first terminal fitting 164 of the second embodiment includes a part extending straight from a base end (upper end) to a tip (lower end) in a longitudinal direction (vertical direction) of a busbar, and a part on a tip side of each first terminal fitting 164 is folded toward a second connecting portion 20 (laterally inward). Therefore, in the second embodiment, a bent portion 168 serving as a resilient deforming portion is constituted by the folded part on the tip side in each first terminal fitting 164, and a first connecting portion 170 is constituted by a part extending toward the base end side (upper side) by being folded by the bent part 168 in each first terminal fitting 164.

Also in the connector unit 160 of the second embodiment structured as described above, a tip part (lower end part) of each first terminal fitting 164 is inserted into a terminal accommodating portion 56 through a through hole 112 of a shield shell 44 and an insertion hole 70 of each housing 42, whereby the laterally inner surface of each first connecting portion 170 and the laterally outer surface of each second connecting portion 20 contact. That is, as each first connecting portion 170 and each second connecting portion 20 contact, each first connecting portion 170 is resiliently deformed in a direction separating from the second connecting portion 20 by the resilient deformation of the bent part 168, and inserted while sliding on the laterally outer surface of the second connecting portion 20. By a resilient restoring force of the bent part 168, each first connecting portion 170 is pressed against the second connecting portion 20 and each second connecting portion 20 is pressed against a contact portion 109 of the shield shell 44 via a heat dissipating member 92.

Accordingly, also in the connector unit 160 of the second embodiment, effects similar to those of the connector unit 10 in the first embodiment can be exhibited. Particularly, since each bent part 168 is formed by folding the busbar, a wide region of the bent part 168 can be ensured. Further, by adjusting a bending angle of each bent part 168, a laterally outward displacement amount of each first connecting portion 170 when each first connecting portion 170 and each second connecting portion 20 contact can be adjusted. Therefore, the magnitude of insertion resistance (sliding resistance) at the time of inserting each first connecting portion 170, the magnitude of a contact pressure between each first connecting portion 170 and each second connecting portion 20 and the like can be adjusted and a degree of freedom in design is improved.

### Third Embodiment

Next, a connector unit 180 of a third embodiment of the present disclosure is described using FIGS. 11 and 12. The connector unit 180 of the third embodiment basically has a similar structure to the connector unit 10 of the first embodiment, but differs from the connector unit 10 in that a multi-contact spring 186 serving as a resilient deforming portion is fixed and provided on a tip part (lower end part) of each first terminal fitting 184 in a first connector 182. Note that a second connector 166 is not described in detail since having a similar structure to that of the second embodiment.

Each first terminal fitting 184 of the third embodiment includes a part extending straight from a base end (upper end) to a tip (lower end) in a longitudinal direction (vertical direction) of a busbar. When a tip part of each first terminal fitting 184 is inserted into a terminal accommodating portion 56 of a housing 42, the tip part of each first terminal fitting 184 provided with the multi-contact spring 186 indirectly contacts a second connecting portion 20 via the multi-contact spring 186. Therefore, in the third embodiment, a first connecting portion 188 is constituted by the tip part provided with the multi-contact spring 186 in each first terminal fitting 184.

Here, the multi-contact spring 186 is made of metal and provided with a plurality of crest portions 190 projecting laterally inward (toward the second connecting portion 20) by being cut and raised from a metal flat plate. The plurality of these crest portions 190 are provided in alignment in the front-rear direction and alternately extend out upward and downward in the front-rear direction. Projecting top parts of these crest portions 190 are parts to be substantially held in contact with the second connecting portion 20, and each crest portion 190 is resiliently deformable in a direction to reduce a projecting dimension thereof by contacting the second connecting portion 20.

In the connector unit 180 of the third embodiment, the tip part (lower end part) of each first terminal fitting 184 is inserted into the terminal accommodating portion 56 through a through hole 112 of a shield shell 44 and an insertion hole 70 of the housing 42, whereby the respective crest portions 190 contact the second connecting portion 20. That is, by inserting each first connecting portion 188 into the terminal accommodating portion 56, the respective crest portions 190 in the multi-contact spring 186 slide on the laterally outer surface of the second connecting portion 20 while being resiliently deformed in the direction to reduce the projecting dimension. The projecting top parts of the respective crest portions 190 are pressed against the second connecting portion 20 by the resilient restorative deformation of these crest portions 190, whereby each first connecting portion 188 is indirectly pressed against the second connecting portion 20 via the multi-contact spring 186. As a result, each second connecting portion 20 is pressed against a contact portion 109 of the shield shell 44 via a heat dissipating member 92.

Accordingly, also in the connector unit 180 of the third embodiment, effects similar to those of the connector unit 10 in the first embodiment can be exhibited. Particularly, since the first terminal fitting 184 is provided with the separate multi-contact spring 186 serving as the resilient deforming portion, the first connector 182 can be simply configured by fixing the multi-contact spring 186 to each first terminal fitting 184 later without forming each first terminal fitting 184 into a complicated shape.

### Fourth Embodiment

Next, a connector unit 200 of a fourth embodiment of the present disclosure is described using FIGS. 13 and 14. The connector unit 200 of the fourth embodiment basically has a similar structure to the connector unit 10 of the first embodiment, but differs from the connector unit 10 in that a bent portion 206 serving as a resilient deforming portion is formed in a tip part (lower end part) of each first terminal fitting 204 by cutting and raising a busbar constituting the first terminal fitting 204 in a first connector 202. Note that a second connector 166 is not described in detail since having a similar structure to that of the second embodiment.

The tip part of each first terminal fitting 204 of the fourth embodiment is substantially in the form of a rectangular flat plate as whole, and a first connecting portion 208 is formed by cutting and raising a widthwise intermediate part of the busbar into a cantilever shape over a predetermined dimension in one place in a longitudinal direction (vertical direction). Specifically, in a tip part of each busbar, a clearance 210 is provided on three sides (both front and rear sides and lower side) around the first connecting portion 208, and an outer peripheral side of the first connecting portion 208 is covered across the clearance 210 by a frame-like portion 212. In this way, each first connecting portion 208 is coupled to the busbar in an upper end part, and resiliently deformable in the lateral direction with a coupling portion as a base point. Each first connecting portion 208 is bent laterally inward in this coupling portion and projects further laterally inward than a base end part of the busbar. Therefore, in the fourth embodiment, the bent portion 206 is constituted by the coupling portion of each first connecting portion 208 and each busbar.

In the connector unit 200 of the fourth embodiment, the tip part (lower end part) of each first terminal fitting 204 including the frame-like portion 212 is inserted into a terminal accommodating portion 56 through a through hole 112 of a shield shell 44 and an insertion hole 70 of a housing 42, whereby the inner surface of each first connecting portion 208 contacts the laterally outer surface of a second connecting portion 20. In this way, each first connecting portion 208 slides on the laterally outer surface of the second connecting portion 20 while being displaced laterally outward by the resilient deformation of the bent portion 206. By a resilient restoring force of the bent part 206, each first connecting portion 208 is pressed against the second connecting portion 20 and each second connecting portion 20 is pressed against a contact portion 109 of the shield shell 44 via a heat dissipating member 92.

Accordingly, also in the connector unit 200 of the fourth embodiment, effects similar to those of the connector unit 10 in the first embodiment can be exhibited. Particularly, since each first connecting portion 208 and each bent portion 206 are formed by cutting and raising the busbar in the fourth embodiment, it is not necessary to adopt other members in forming each first connecting portion 208 and each bent portion 206 and increases in the number of components and cost are avoided. Further, by adjusting a bending angle of each bent portion 206, a laterally inward projection amount of each first connecting portion 208 can be adjusted and the magnitude of a contact pressure between each first connecting portion 208 and each second connecting portion 20 and the like can be adjusted, wherefore a degree of freedom in design can be improved.

### Modifications

Although the first to fourth embodiments have been described in detail as specific examples of the present disclosure above, the present disclosure is not limited by this specific description. Modifications, improvements and the like within a range in which the aim of the present disclosure can be achieved are included in the present disclosure. For example, the following modifications of the embodiments are also included in the technical scope of the present disclosure.

(1) Although the heat dissipating member 92 having a higher thermal conductivity than the housing 42 is adopted as the insulating member provided between each second connecting portion 20 and the shield shell 44 in the above embodiments, the insulating member is not limited as long as having an insulating property. That is, a wall portion of a housing may be adopted as an insulating member, and a second connecting portion may be pressed against a shield shell via a laterally inner wall portion of the housing without providing a side window portion serving as an opening in a left or right wall portion of a housing body.

(2) Although the bent portion 28 bent laterally inward between the base end portion 26 and the first connecting portion 16 is provided in each first terminal fitting 18 in the first embodiment, there is no limitation to this form. That is, a part closer to a tip side than a base end portion to be fixed to a terminal block in each first terminal fitting may extend substantially straight in a direction inclined laterally inward toward a lower side without being bent or curved. In this case, a resilient deforming portion can be grasped to be located on a boundary part between a non-displaceable part fixed to the terminal block and a part obliquely extending laterally inward (part to be displaced laterally outward at the time of contact with a second connecting portion).

(3) Although the resilient deforming portion (bent portion 28, 168, 206, multi-contact spring 186) is provided in one place in the longitudinal direction (vertical direction) of each first terminal fitting 18, 164, 184, 204 in the above embodiments, there is no limitation to this form and resilient deforming portions may be provided in a plurality of places in a longitudinal direction of a first terminal fitting. That is, each first terminal fitting may be curved or bent in a plurality of places in the longitudinal direction to form the resilient deforming portions or a plurality of resilient deforming portions (bent portion 28 and multi-contact spring 186) may be provided by adopting the multi-contact spring 186 of the third embodiment on the tip part (lower end part) of the first terminal fitting 18 in the first embodiment.

(4) Although the pair of first connecting portions 16, 170, 188, 208 and the pair of second connecting portions 20 are provided in the above embodiments, the numbers of these are not limited. One, three or more first connecting portions may be provided and one, three or more second connecting portions may be provided.

### LIST OF REFERENCE NUMERALS

10 connector unit (first embodiment)
12 first connector
14 second connector
16 first connecting portion
18 first terminal fitting
20 second connecting portion
22 second terminal fitting
24 terminal block
26 base end portion
28 bent portion (resilient deforming portion)
29 bolt insertion hole
30 tip curved portion
32 terminal holding portion
34 terminal insertion hole
36 receptacle
38 fixing piece
40 collar
42 housing
44 shield shell
46 positioning recess
48 coated wire
50 wire fixing portion
52 core wire
54 insulation coating
55 housing side assembly
56 terminal accommodating portion
58 upper wall portion
60 lower wall portion
62 left wall portion
64 right wall portion
66 front wall portion
68 rear opening
70 insertion hole
72 side window portion (opening)
74 resilient piece
76 locking claw
78 lock protrusion
80 housing body
82 terminal fixing portion
84 lower window portion
86 base plate portion
88 lock frame body
90 positioning protrusion
92 heat dissipating member (insulating member)
94 connecting portion side contact surface
96 shell side contact surface
98 upper wall portion
100 lower wall portion
102 left wall portion
104 right wall portion
106 front wall portion
108 partitioning portion (wall portion)
109 contact portion
110 locking recess
112 through hole
114 inner tube portion
116 lock recess
118 outer tube portion
120 cut portion
122 bolt insertion hole
124 lock claw portion
126 fixing portion
128 engaging recess
130 front retainer
132 terminal insertion window
134 lock protrusion
136 waterproof rubber
138 back retainer
140 upper retainer
142 lower retainer
144 lock frame body
146 engaging protrusion
148 shield bracket
150 tubular wall portion
152 forward projecting portion
154 bolt insertion hole
160 connector unit (second embodiment)
162 first connector
164 first terminal fitting
166 second connector
168 bent portion (resilient deforming portion)
170 first connecting portion
180 connector unit (third embodiment)
182 first connector
184 first terminal fitting
186 multi-contact spring (resilient deforming portion)
188 first connecting portion
190 crest portion
200 connector unit (fourth embodiment)
202 first connector
204 first terminal fitting
206 bent portion (resilient deforming portion, coupling portion)
208 first connecting portion
210 clearance
212 frame-like portion

1. A connector unit, comprising a first connector and a second connector,
the first connector including an insulating terminal block and a first terminal fitting,
the first terminal fitting including a base end portion held in the terminal block and a first connecting portion provided on a tip side projecting from the terminal block,
the second connector including a second terminal fitting having a second connecting portion to be connected to the first connecting portion, an insulating housing for accommodating the second terminal fitting and a shield shell for covering an outer surface of the housing,
the housing including an insertion hole, the first connecting portion being inserted and arranged in the insertion hole, the second connecting portion being arranged to be contactable with the first connecting portion in the insertion hole,
the first terminal fitting integrally including a resilient deforming portion for resiliently deforming the first connecting portion in a direction separating from the second connecting portion as contacting the second connecting portion, and
the first connecting portion being pressed against the second connecting portion and the second connecting portion being pressed against the shield shell via an insulating member by a resilient restoring force of the resilient deforming portion.

2. The connector unit of claim 1, wherein:
the first terminal fitting integrally includes a bent portion for displacing the first connecting portion toward the second connecting portion with respect to the base end portion, the resilient deforming portion being constituted by the bent portion,
the bent portion is resiliently deformed by contact of the first and second connecting portions, and
the first connecting portion is pressed against the second connecting portion and the second connecting portion is pressed against the shield shell via the insulating member by a resilient restoring force of the bent portion.

3. The connector unit of claim 1, wherein:
the insulating member includes a heat dissipating member having a higher thermal conductivity than the housing,
the heat dissipating member has a connecting portion side contact surface to be held in contact with the second connecting portion and a shell side contact surface to be held in contact with the shield shell by being exposed from an opening of the housing, and
the second connecting portion pressed by the first connecting portion is pressed against the shield shell via the heat dissipating member by the resilient restoring force of the resilient deforming portion.

4. The connector unit of claim 2, wherein the first terminal fitting is constituted by a busbar and the bent portion is provided by bending or curving one place in a longitudinal direction of the busbar in a plate thickness direction.

5. The connector unit of claim 4, wherein the bent portion is provided by bending a part between the base end portion and the first connecting portion in the longitudinal direction of the busbar in the plate thickness direction.

6. The connector unit of claim 4, wherein a tip curved portion inclined in a direction opposite to the bent portion in the plate thickness direction of the busbar is provided on a tip part of the busbar.

7. The connector unit of claim 4, wherein the first connecting portion is formed by cutting and raising a widthwise intermediate part of the busbar into a cantilever shape over a predetermined dimension in one place in the longitudinal direction of the busbar, and the bent portion is constituted by a coupling portion of the first connecting portion to the busbar.

8. The connector unit of claim 4, wherein the bent portion is provided to be curved in the plate thickness direction by curvedly folding a part on the tip side in the longitudinal direction of the busbar toward the second connecting portion, and the first connecting portion is constituted by a part folded toward the second connecting portion in the busbar.

9. The connector unit of claim 1, wherein:
the first connector includes a pair of the first terminal fittings,
the second connector includes a pair of the second terminal fittings,
one second connecting portion and the other second connecting portion of the pair of second terminal fittings are arranged to face each other across a wall portion of the shield shell,
one insertion hole and the other insertion hole are arranged on both sides in a facing direction of the one and the other second connecting portions across the wall portion of the shield shell, and
one first connecting portion and the other first connecting portion of the pair of first terminal fittings respectively inserted in the one and the other insertion holes are pressed in directions approaching each other by resilient restoring forces of the respective resilient deforming portions.
